(19) United States
(12) Patent Application Publication
(10) Pub. No.: US 2015/0039108 A1
(43) Pub. Date: Feb. 5, 2015

(54) APPARATUS AND METHOD FOR PROCESSING RECEIVER-CUSTOMIZED MESSAGE

(71) Applicant: Hyundai Motor Company, Seoul (KR)

(72) Inventor: Soon Kwon PAIK, Seoul (KR)

(73) Assignee: Hyundai Motor Company, Seoul (KR)

(21) Appl. No.: 14/081,537

(22) Filed: Nov. 15, 2013

(30) Foreign Application Priority Data
Jul. 30, 2013 (KR) 10-2013-0090130

(51) Int. Cl. G06F 3/16

(52) U.S. Cl. CPC G06F 3/167
USPC 700/94

(57) ABSTRACT

An apparatus for processing a receiver-customized message includes a voice recognizer to recognize an instruction to send a message from a driver. An information collector collects information included in the instruction. A message creator creates a message including the information collected by the information collector taking into account the relationship with a receiver. A message receiver receives a message, and a message output outputs an audio guide message for the message received by the message receiver. A controller is configured to analyze the message received by the message receiver, to determine an output level of the message based on a degree of risk, and to control the message output such that it outputs an audio guide message suitable for the determined level.

### CROSS-REFERENCE TO RELATED APPLICATION

This application is based on and claims the benefit of priority to Korean Patent Application No. 10-2013-0090130, filed on Jul. 30, 2013 in the Korean Intellectual Property Office, the disclosure of which is incorporated herein in its entirety by reference.

### TECHNICAL FIELD

The present disclosure relates to an apparatus and a method for processing a receiver-customized message.

In the specification, a message refers to a message including information about operating an automobile system, and includes a message including location information, a message including video information and the like.

### BACKGROUND

It is known that texting while driving is more dangerous than drunk driving. As an example, a Virginia Tech Transportation Institute study found that texting while driving raises a truck driver's crash risk by 23 times. In the U.S., six states prohibit the use of a cell phone while driving, and 17 states ban text messaging while driving. The U.S. senate is preparing a federal law to prohibit text messaging while driving in all of the states.

In addition, states that do not ban text messaging while driving will be heavily sanctioned. This sanction demands that every state bans texting while driving within two years, otherwise the government deducts 25% of the federal highway funds every year from a state which does not obey. In the state of California, if a driver who is texting while driving is caught, the driver is fined $20 for the first time and $50 after the second time and later.

Because the driver of the recent train crash in Los Angeles was distracted by text messaging, all train conductors and railroad personnel are also banned from using cell phones and text messaging in the state of California.

Some institutes announced that a study shows that texting while driving increases probability of traffic accidents by 8 times, while driving by a drunk driver with blood alcohol level of 0.08%, which is the legal limit, increases probability of traffic accidents by 4 times. Further, reading a message as well as texting is equally risky since it distracts the driver's sight. Statistics says there are one hundred twenty million mobile phone subscribers in U.S. and 60% of the usage amount of cell phone is conducted while driving.

Researchers at the University of Utah invented a special automobile ignition key with Bluetooth function, which automatically places a driver's cell phone in “driving mode” when turning on the engine, so that the driver cannot use his cell phone to talk or send text message. However, although it may reduce traffic accidents, it causes bigger problems since it completely inhibits reading messages while driving.

Under certain circumstances, it may be necessary for a driver to check a text message even while driving without being distracted.

### SUMMARY

The present disclosure has been made to solve the above-mentioned problems occurring in the prior art while advantages achieved by the prior art are maintained intact.

An aspect of the present disclosure provides an apparatus and a method for processing a receiver-customized message allowing a driver to check text messages depending on situations without being distracted. Text message information is collected from an automobile system pursuant to an instruction to send a message by recognizing a driver's voice. The message, taking into account the relationship with a message receiver, is created, an output level of a message based on a degree of risk when a message is received from the outside is determined, and an audio guide message suitable for the level is output.

Other aspects of the present disclosure are not limited to the above-described object and other objects, and advantages can be appreciated by the following description described with reference to the embodiments of the present disclosure. Further, it will be easily appreciated that the objects and advantages of the present disclosure can be realized by means, and a combination thereof, recited in the appended claims.

According to an exemplary embodiment of the present disclosure, an apparatus for processing a receiver-customized message includes a voice recognizer configured to recognize an instruction to send a message from a driver. An information collector collects information included in the instruction. A message creator creates the message including the information collected by the information collector taking into account the relationship with a receiver. A message receiver receives a message, and a message output outputs an audio guide message for the message received by the message receiver. A controller is configured to analyze the message received by the message receiver, to determine an output level of the message based on a degree of risk, and to control the message output such that it outputs an audio guide message suitable for the determined level.

According to another exemplary embodiment of the present disclosure, a method for processing a receiver-customized message includes recognizing, by a voice recognizer, an instruction to send a message from a driver. An information collector collects information included in the instruction from an automobile system. A message creator creates the message including the collected information taking into account relationship with a receiver under the control of a controller.

According to another exemplary embodiment of the present disclosure, a method for processing a receiver-customized message includes receiving a message by a message receiver. A controller analyzes the received message, and determines an output level of the message based on a degree of risk. A message output outputs an audio guide message suitable for the determined output level.

### BRIEF DESCRIPTION OF THE DRAWINGS

The above and other objects, features, and advantages of the present disclosure will be more apparent from the following detailed description taken in conjunction with the accompanying drawings.

FIG. 1 is a block diagram of an apparatus for processing a receiver-customized message according to an embodiment of the present disclosure.

FIG. 2 is a flowchart illustrating a method for processing a receiver-customized message according to an embodiment of the present disclosure.

FIG. 3 is a flowchart illustrating a method for processing a receiver-customized message according to another embodiment of the present disclosure.

### DETAILED DESCRIPTION

The above objects, features, and advantages will be more apparent from the detailed description with reference to the accompanying drawings, and therefore, the technical ideas of the present disclosure can be easily practiced by a person with ordinary skill in the art to which the present disclosure pertains. In describing the present disclosure, a detailed description of well-known technology relating to the present disclosure may be omitted if it is considered that it may unnecessarily obscure the gist of the present disclosure. Hereinafter, embodiments of the present disclosure will be described in detail with reference to the accompanying drawings.

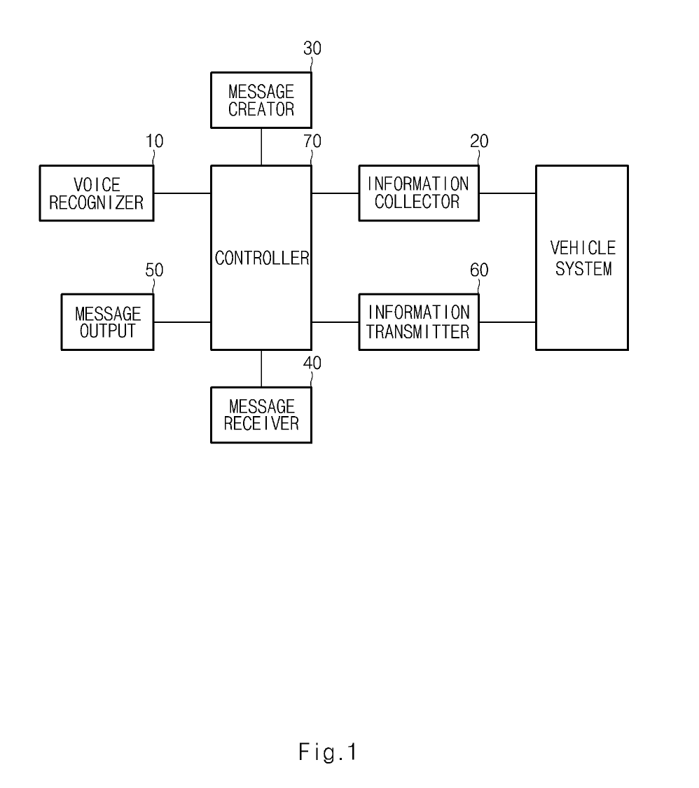

FIG. 1 is a block diagram of an apparatus for processing a receiver-customized message according to an embodiment of the present disclosure.

As shown in FIG. 1, the apparatus for processing a receiver-customized message according to an embodiment of the present disclosure includes a voice recognizer 10, an information collector 20, a message creator 30, a message receiver 40, a message output 50, an information transmitter 60, and a controller 70.

Specifically, the voice recognizer 10 recognizes a message transmission instruction from a driver. The examples of the instruction include “send music information as a message to Julia,” “send location information as a message to Julia,” “send temperature information as a message to Julia,” “send video information as a message to Julia,” “send automobile condition information as a message to Julia,” “Yes” which means permission, “No” which means non-permission, etc. The music information includes titles, singers, writers, and the like, the location information includes GPS location coordinates, and the video information includes titles. The music information may include music source data, and the video information may include video data.

The information collector 20 collects information contained in the message transmission instruction from the driver under the control of the controller 70 in cooperation with an automobile system. The automobile system includes an audio device, a navigation device, an air conditioner, a communication device (for mobile communication, WiFi, Bluetooth, and the like), automobile condition managing device, a video (front/rear camera video) acquiring device, and the like.

The message creator 30, under the control of the controller 70, creates the message containing the information collected by the information collector 20 taking into account the relationship with a receiver.

For example, assuming that the automobile system is playing the music, “Rolling in the Deep” by Adele, and the voice instruction from the driver is “send music information as a message to Julia,” the controller 70 searches a telephone number storage (not shown) for a group including “Julia.” If the found group is a girlfriend, which means very intimate relationship, the controller 70 controls the message creator 30 such that it creates a message saying “Rolling in the Deep by Adele, try this˜ [symbol] , Julia.”

If the found group is his boss at work, the created message may say “Would you like to listen to Rolling in the Deep by Adele, Ms. Roberts?”

If the apparatus for processing a receiver-customized message according to an embodiment of the present disclosure is compatible with the driver's mobile communication terminal (such as a smart phone), the controller 70 searches the phone number storage of the mobile communication terminal for a group of “Julia.” If the apparatus is not compatible with the driver's mobile communication terminal, the apparatus is supposed to have a separate storage (not shown) in which personal information (such as names, phone numbers, and e-mail addresses) is written by group.

The message thus created is transmitted to the terminal of Julia via a message transmitter (not shown) under the control of the controller 70.

The message receiver 40 receives a message. The message not only includes a message from a mobile device such as a mobile phone but also includes all kinds of messages associated with directly or indirectly with users' interaction such as human to human, human to machine, and machine to machine exchanged between automobiles or between telematics centers in automobiles.

The message output 50, under the control of the controller 70, outputs an audio guide message associated with the message received by the message receiver 40.

For example, when the message saying “Rolling in the Deep by Adele, try this˜ [symbol] , Julia” is received, the audio guide message associated with this message may say “would you like to listen to the music in the message?”

The information transmitter 60 transmits the information (such as music information and video information) contained in the received message to the automobile system under the control of the controller 70. That is, the information transmitter 60 is operated under control of the controller 70.

The controller 70 controls overall components so that they perform their functions. That is, when the voice recognizer 10 recognizes a voice to transmit a message from a driver, the controller 70 controls the information collector 20 so that it collects pieces of information to be included in the message to be transmitted, learns the relationship between the driver and a receiver via the telephone number storage (not shown), and controls the message creator 30 so that it creates the message including the collected pieces of the information taking into account the relationship.

In addition, the controller 70 analyzes the message received by the message receiver 40, determines the output level of the message based on the degree of risk, and controls the message output 50 so that it outputs an audio guide message suitable for the determined level.

Hereinafter, the process of calculating the degree of risk by the controller 70 will be described.

Initially, a first value (constant) is detected which represents the relation between the traveling speed of an automobile collected by the information collector 20 from a navigation device and a speed limit of a current road.

For example, if the traveling speed is above the speed limit, the first value is, for example, 3 as a high value (A), if the traveling speed is equal to the speed limit, the first value is, for example, 2 as a middle value (B), and if the traveling speed is below the speed limit, the first value is, for example, 1 as a low value (C).

Then, a second value is detected which corresponds to traffic information collected by the information collector 20 from the navigation device. The traffic information includes congested, slow, and free-flow conditions.

For example, if the traffic information indicates the congested condition, the second value is, for example, 3 as a high value (A), if the traffic information indicates the slow condition, the second value is, for example, 2 as a middle value (B), and if the traffic information indicates the free-flow condition, the second value is, for example, 1 as a low value (C).

The high value (A) when the traveling speed is above the speed limit is equal to the high value (A) when the traffic information indicates the congested condition, the middle value (B) when the traveling speed is equal to the speed limit is equal to the middle value (B) when the traffic information indicates the slow condition, and the low value (C) when the traveling speed is below the speed limit is equal to the low value (C) when the traffic information indicates the free-flow condition.

Then, the controller 70 selects a higher value from between the first values and second values. This is called as a selection value λ. If the first values and second values are identical, any of them may be selected.

Then, the controller 70 calculates the degree of risk γ using Equation 1 below.

γ=ω·log 10(λ/B) [Equation 1]

Where ω denotes a weight which is a constant, and B denotes a middle value.

The controller 70 may determine the output level of the received message depending on the comparison result of the degree of risk, thus calculated with a predetermined threshold.

For instance, if the degree of risk exceeds the predetermined threshold value, the output level is determined to be a high level, and a message is output such as “this message includes video information, and thus will be presented when the automobile is stationary (the gear shift lever is in a parking or neutral position).”

On the contrary, if the degree of risk does not exceed the predetermined threshold value, the output level is determined to be a low level, and a message is output such as “Would you like to see the video?” If a driver inputs a permission signal, then the video is presented.

As another example, if the degree of risk exceeds the predetermined threshold value, the output level is determined to be the high level, and a message is output such as “Would you like to listen to music?” If the driver inputs the permission signal, then the music is played.

On the contrary, if the degree of risk does not exceed the predetermined threshold value, the output level is determined to be the low level, and a message is output such as “music will be played.” The music is played without requesting the driver's permission.

Incidentally, when the controller 70 recognizes permission through the voice recognizer 10, the controller 70 controls the information transmitter 60 such that it transmits the information extracted from the received message to the automobile system.

For example, if an audio guide message says “Would you like to watch video?” and the driver permits, video information is transmitted to the automobile system.

In an embodiment, the received message may include a firmware upgrade message.

Incidentally, embodiments of the present disclosure may further include a usage frequency calculator (not shown) and an insurance company server interconnector (not shown). The operation thereof will be described.

The usage frequency calculator calculates the usage frequency, i.e., the operation rate during driving of the apparatus for processing a receiver-customized message according to the present disclosure.

During the operation of the apparatus for processing a receiver-customized message according to the present disclosure, a driver may check messages depending on situations while safely driving. This is advantageous in that the rate of traffic accidents due to negligence of drivers is significantly lowered. However, some drivers may not operate the apparatus for processing a receiver-customized message according to the present disclosure. To complement this, a scheme to discount the insurance premium is provided according to the usage frequency of the apparatus for processing a receiver-customized message according to the present disclosure.

Accordingly, the insurance sever interconnector, under the control of the controller 70, transmits usage frequency information (a log file) calculated by a usage frequency calculator to the server of an insurance company.

Further, an embodiment of the present disclosure may further include a message pattern analyzer so that messages and interactions associated with messages are monitored and profiled, to improve reliability whenever a new action is given.

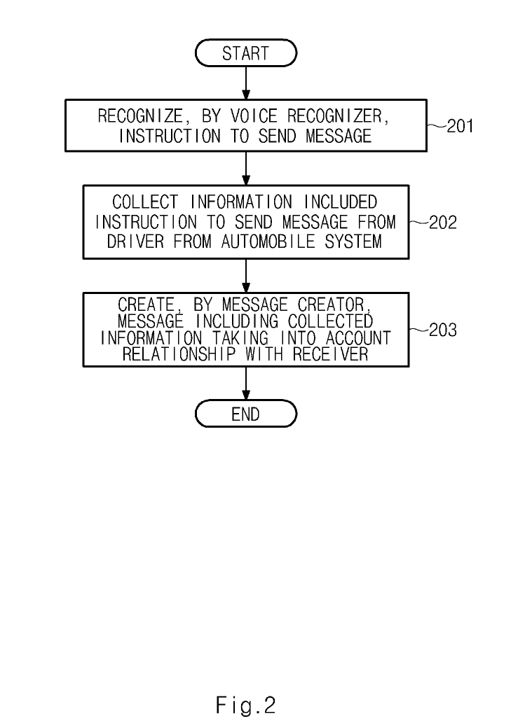

FIG. 2 is a flowchart illustrating a method for processing a receiver-customized message according to an embodiment of the present disclosure, especially for processing a transmission message.

Initially, the voice recognizer 10 recognized an instruction to send a message from a driver (201).

Then, the information collector 20 collects information included in the instruction from the driver using an automobile system (202).

The message creator 30, under the control of the controller 70, creates a message containing the information collected by the information collector 20 taking into account the relationship with a receiver (203).

The message thus created is transmitted to the receiver under the control of the controller 70.

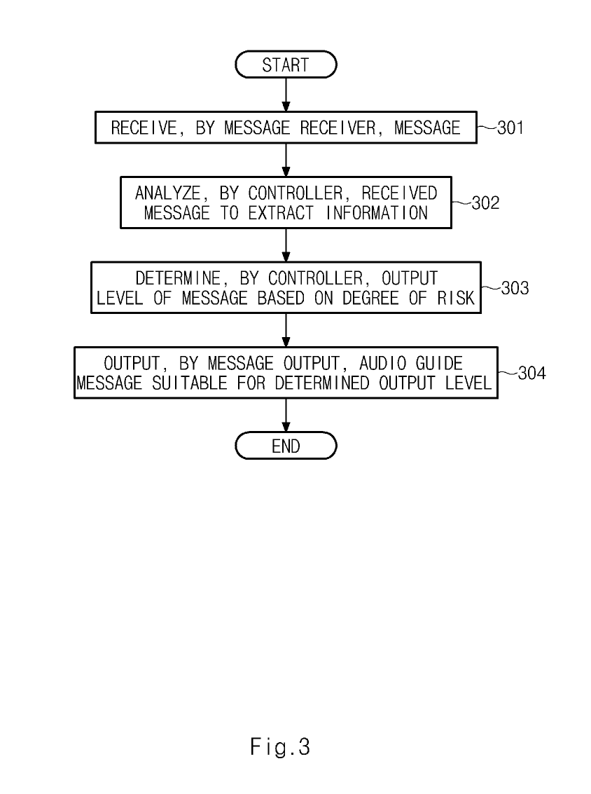

FIG. 3 is a flowchart illustrating a method for processing a receiver-customized message according to another embodiment of the present disclosure.

Initially, the message receiver 40 receives a message (301). The controller 70 analyzes the message received by the message receiver 40 to extract information (302) and determines the output level of the message based on the degree of risk (303). Then, the message output 50 outputs an audio guide message suitable for the determined output level (304).

If a driver inputs permission in response to the audio guide message, the controller 70 transmits the information (such as music information) extracted from the received message to the automobile system.

The above-described method according to the embodiment of the present disclosure may be written in a computer program. Codes and code segments configuring the computer program may be easily deduced by computer programmers in the art. In addition, the computer program is stored in a computer readable recording medium (information storage medium) and is read and executed by the computer, thereby implementing the method according to the embodiment of the present disclosure. The recording medium includes all kinds of storage medium readable by the computer.

As set forth above, according to embodiments of the present disclosure, a driver can check text messages depending on situations without being distracted, by way of collecting information to be included in a message from an automobile system pursuant to an instruction to send a message by recognizing the driver's voice. A message is created by taking into account the relationship with a message receiver, an output level of a message is determined based on a degree of risk when a message is received from the outside, and an audio guide message suitable for the level is output.

The present disclosure described above may be variously substituted, altered, and modified by those skilled in the art to which the present disclosure pertains without departing from the scope and sprit of the present disclosure. Therefore, the present disclosure is not limited to the above-mentioned exemplary embodiments and the accompanying drawings.

What is claimed is:

1. An apparatus for processing a receiver-customized message, the apparatus comprising:
a voice recognizer to recognize an instruction to send a message from a driver;
an information collector to collect information included in the instruction;
a message creator to create a message including the information collected by the information collector taking into account the relationship with a receiver;
a message receiver to receive a message;
a message output to output an audio guide message for the message received by the message receiver; and
a controller configured to analyze the message received by the message receiver, to determine an output level of the message based on a degree of risk, and to control the message output such that it outputs an audio guide message suitable for the determined level.

2. The apparatus according to claim 1, wherein the controller further controls the information collector such that it collects the information based on a recognition result by the voice recognizer, and controls the message creator such that it creates a message including the collected information taking into account the relationship with the receiver.

3. The apparatus according to claim 2, wherein the controller, when the apparatus is interconnected with a mobile communication terminal of the driver, acquires the relationship information with the receiver from a phone number storage of the mobile communication terminal.

4. The apparatus according to claim 2, further comprising a phone number storage in which names and phone numbers are written by a group, wherein the controller acquires the relationship information with the receiver from the phone number storage.

5. The apparatus according to claim 1, wherein the controller calculates the degree of risk γ using the following equation
γ=ω*log 10(λ/B)
wherein ω denotes a weight which is a constant, and λ denotes a higher value between a first value that represents the relationship between a traveling speed and a speed limit, and a second value that represent traffic information in a number, and
wherein each of the first and second value includes a high value A, a middle value B, and a low value C which are constant values.

6. The apparatus according to claim 1, further comprising an information transmitter configured to transmit the information extracted by the controller to an automobile system, wherein the controller operates the information transmitter upon a driver's permission.

7. The apparatus according to claim 1, further comprising:
a usage frequency calculator to calculate the usage frequency of the apparatus; and
an insurance company server interconnector to transmit the usage frequency calculated by the usage frequency calculator to a server of an insurance company.

8. A method for processing a transmission message in an apparatus for processing a receiver-customized message, the method comprising:
recognizing, by a voice recognizer, an instruction to send a message from a driver;
collecting, by an information collector, information included in the instruction from an automobile system;
creating, by a message creator, a message including the collected information taking into account a relationship with a receiver under control of a controller.

9. The method according to claim 8, wherein the creating of the message includes acquiring, by the controller, when the apparatus is interconnected with a mobile communication terminal of the driver, the relationship information with the receiver from a phone number storage of the mobile communication terminal.

10. The method according to claim 8, wherein the creating of the message includes:
preparing a phone number storage in which names and phone numbers are written by group; and
acquiring, by the controller, when the apparatus is not interconnected with a mobile communication terminal of the driver, the relationship information with the receiver from the phone number storage.

11. A method for processing a received message in an apparatus for processing a receiver-customized message, the method comprising:
receiving, by a message receiver, a message;
analyzing, by a controller, the received message;
determining, by the controller, an output level of the message based on a degree of risk; and
outputting, by a message output, an audio guide message suitable for the determined output level.

12. The method according to claim 11, further comprising transmitting, by the controller, the information extracted from the received message to an external automobile system, when permission is input in response to the audio guide message.

13. The method according to claim 11, wherein the determining of the output level includes calculating the degree of risk γ using the following equation
γ=ω*log 10(λ/B)
wherein ω denotes a weight which is a constant, and λ denotes a higher value between a first value that represents a relationship between a traveling speed and a speed limit, and a second value that represent traffic information in a number, and
wherein each of the first and second value includes a high value A, a middle value B and a low value C which are constant values.
